(19) United States
(12) Patent Application Publication
(10) Pub. No.: US 2021/0243782 A1
(43) Pub. Date: Aug. 5, 2021

(54) METHODS OF ENHANCED SPS TRANSMISSION AND HARQ FEEDBACK

(71) Applicant: Honglei Miao, Munich (DE)

(72) Inventor: Honglei Miao, Munich (DE)

(21) Appl. No.: 17/236,702

(22) Filed: Apr. 21, 2021

Related U.S. Application Data
(60) Provisional application No. 63/013,175, filed on Apr. 21, 2020.
(60) Provisional application No. 63/013,361, filed on Apr. 21, 2020.

(51) Int. Cl. H04W 72/12; H04W 72/04; H04W 72/14

(52) U.S. Cl. CPC H04W 72/1273; H04W 72/14; H04W 72/042

(57) ABSTRACT

An apparatus, a method, and a computer-readable storage medium. The apparatus is to encode or decode a radio resource control (RRC) message from a NR evolved Node B (gNB) including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission to the UE, or a plurality of CS-RNTIs to activate, deactivate or retransmit a respective plurality of SPS grants for multicast DL transmission to a plurality of UEs including the UE; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2.

### CROSS REFERENCE TO RELATED APPLICATIONS

This application claims the benefit of and priority from U.S. Provisional Patent Application No. 63/013,175 entitled “Method of Enhanced SPS Transmission,” filed Apr. 21, 2020, and U.S. Provisional Patent Application No. 63/013,361 entitled “Enhanced HARQ Feedback,” filed Apr. 21, 2020, the entire disclosures of which are incorporated herein by reference.

### FIELD

Various embodiments generally may relate to the field of wireless communications.

### BACKGROUND

In new radio (NR) Rel. 16, downlink semi-persistent scheduling (SPS) has been further enhanced to include smaller periodicity and multiple downlink (DL) SPS processes can be configured for a UE to better support the periodic traffic with very high reliability and low latency requirements in the industry use cases. In industry use cases, e.g., motion control, sometimes, groupcast/multicast messages with multiple intended receivers are transmitted from the controller to the User Equipments (UEs). However, so far, NR systems do not support multicast transmission in a Uu interface. Therefore, multicast messages from the application server need to be duplicated by the user plane function (UPF) to all the involved UE specific protocol data unit (PDU) sessions in order to send the messages to the UEs. As a result, the duplicated multicast messages in each UE PDU session are transmitted as a unicast message which are further transmitted to each UE separately over the radio resources.

The state of the art leads to inefficient use of radio resources in the wireless network.

### BRIEF DESCRIPTION OF THE DRAWINGS

FIG. 1 illustrates a wireless network in accordance with various embodiments.

FIG. 2 illustrates a User Equipment (UE) and a Radio Access Node (RAN) in wireless communication according to various embodiments.

FIG. 3 illustrates components according to some example embodiments, the components able to read instructions from a machine-readable or computer-readable medium and perform any one or more of the methodologies discussed herein.

FIG. 4 illustrates a flow chart for a process according to a first embodiment.

FIG. 5 illustrates a flow chart for a process according to a second embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Multicast messages repeatedly transmitted as unicast messages in the state of the art, especially for periodic traffic, can cause a significant consumption of radio resources, leading to a very low spectrum efficiency for information delivery, as well as a large latency delay for different UEs.

It can be beneficial to support multicast/groupcast transmission at least for periodic traffic which yields a persistent traffic demand over a considerable time span. Moreover, due to the open access nature of the wireless medium, it is envisioned that the multicast/groupcast transmission support in the NR Uu interface for periodic traffic can be efficiently realized.

Additionally, for multicast periodic transmission, it can be beneficial to support different types of HARQ-ACK transmissions. For instance, in some cases, it can be beneficial to enable the UE to feedback only NACK when the received PDSCH is not correctly decoded. This can further allow multiple UEs to share the same PUCCH resource for HARQ-ACK feedback to save the uplink (UL) radio resource consumption.

The instant disclosure describes methods to support multicast/groupcast transmission for periodic traffic. Specifically, some proposed multiple configured scheduling radio network temporary identifier (CS-RNTI) configurations enable UE to support both unicast and several multicast/groupcast transmission for periodic traffic flows corresponding to different multicast groups. Such multiple casting group support can be used for grouping UEs according to the subscription of the multicast message as well as the commonality of radio link quality of involved UEs. As a result, the overall system spectrum efficiency can be significantly improved by the additional degree of freedom for radio resource utilization.

The instant disclosure further proposes methods to support different HARQ-ACK types, e.g., ACK-NACK and NACK-Only, for multicast periodic transmission. Specifically, both semi-static and dynamic HARQ-ACK feedback type signalling are proposed. Moreover, HARQ-ACK feedback type can be configured on SPS-Config or PUCCH resource level, which enables the NACK-only HARQ-ACK feedback to be supported for unicast or multicast transmission. With these proposed methods, UE PUCCH resources for multicast periodic traffic transmission can be optimally allocated according to the service QoS as well as radio link quality of each individual UE. As a result, the overall system spectrum and energy efficiency can be considerably improved.

Enhanced SPS Transmission

### Embodiment-1: Enhanced Configured Scheduling-Radio Network Temporary Identifier (CS-RNTI) Configuration

According to a first embodiment, one or more CS-RNTI can be configured to a UE by radio resource control (RRC) signaling by a New Radio Node B (gNB). Specifically, one CS-RNTI may be used for activation/deactivation/retransmission of SPS grant for unicast DL transmission. Other CS-RNTIs can be used for activation/deactivation/retransmission of SPS grants for multicast/groupcast DL transmission. Moreover, according to this embodiment, each SPS configuration may be associated with a particular CS-RNTI, and the SPS config index may be numbered within the group of SPS configurations associated with the same CS-RNTI.

Specifically, the RRC information element (IE) PhysicalCellGroupConfig in the Third Generation Partnership Project (3GPP) Technical Specification (TS) 38.331, “NR; Radio Resource Control (RRC) Protocol Specification (Release 16),” can be enhanced as follows:

```
CS-RNTIType ::=  SEQUENCE {
  cs-RNTI-id  INTEGER (1..maxNrofCS-RNTI),
  cs-RNTI  RNTI-Value
}
PhysicalCellGroupConfig ::=  SEQUENCE {
  ......
  cs-RNTIList  SEQUENCE (SIZE (1..maxNrofCSRNTI))
  OF CS-RNTIType
  ...,
}
```

where
CS-RNTIType defines a new type for CS-RNTI value definition. It includes the following parameters:
   cs-RNTI-id defines the index of the CS-RNTI configured for the UE, is used to identify the respective CS-RNTI in other RRC configuration IEs. Parameter maxNrofCS-RNTI specifies the maximum number of CS-RNTI supported in the system.
   cs-RNTI defines the CS-RNTI value.
cs-RNTIList defines a list of CS-RNTI values being configured to UE for the physical cell group. Each CS-RNT in the list corresponds to a particular cast type, e.g., unicast or groupcast/multicast, or broadcast.

With the above proposed CS-RNTI configuration enhancement, a UE can be configured with several CS-RNTI values. One configured CS-RNTI can be used for scheduling a unicast DL SPS transmission. The other configured CS-RNTIs can be used for scheduling groupcast SPS transmission for different groups in the cell. For example, in a serving cell, multiple groupcast groups can be formed, and each group contains non-overlapped/partially overlapped set of UEs. All the UEs in the same casting group, shall be configured with the same CS-RNTI value of the group. Different UEs can be configured with different number of CS-RNTIs depending on the number of casting groups which the UE belongs to.

### Embodiment-2: Enhanced SPS Configuration

According to a second embodiment, SPS configuration, namely the parameter SPS-Config in the Third Generation Partnership Project (3GPP) Technical Specification (TS) 38.331, “NR; Radio Resource Control (RRC) Protocol Specification (Release 16),” (hereinafter 38.331 Rel. 16) may be enhanced to include the parameters defining the index of associated CS-RNTI, namely cs-RNTI-id, and the PDSCH data scrambling IDs, namely dataScramblingIdentityPDSCH, and optional dataScramblingIdentityPDSCH2. When these parameters are not configured in SPS-Config, the default value of cs-RNTI-id is 1, and dataScramblingIdentityPDSCH, and additionaldataScramblingIdentityPDSCH2 shall correspond to the respective ones configured in the PDSCH-Config in the same bandwidth part. As a result, the CS-RNTI-ID of 1 corresponds to the CS-RNTI used for unicast SPS DL transmission.

Moreover, a new parameter SPS-ConfigIndex-rXX, where XX can be a value larger than 16 in SPS-Config shall be numbered within the SPS-Config group corresponding to same CS-RNTI. Hence the SPS-ConfigIndex-rXX in two SPS-Configs configured with different CS-RNTI values can share the same value, but the harp-ProcID-Offset-r16 shall have different values to have non-overlapped HARQ process ID spaces for different SPS-Configs corresponding to different CS-RNTI. Moreover, a new parameter dmrs-Config-rXX of type DMRS-DownlinkConfig from TS 38.331 Rel. 16, is also configured in SPS-Config to define the required parameters used for DMRS sequence generation and resource mapping calculation. Specifically, SPS-Config in TS 38.331 Rel. 16 can be enhance as follows.

```
SPS-Config ::=  SEQUENCE {
  ...,
  [[
  SPS-ConfigIndex-rXX  SPS-ConfigIndex-rXX
    cs-RNTI-id-rXX  INTEGER (1..maxNrofCS-RNTI),
    dataScramblingIdentityPDSCH-rXX INTEGER (0..1023)
    dataScramblingIdentityPDSCH2-rXX INTEGER (0..1023)
dmrs-Config-rXX  SetupRelease {DMRS-DownlinkConfig }
  ]]
}
```

where
SPS-ConfigIndex-rXX configures the SPS-Config index used in the release XX. The index is defined within the group of SPS-Configs associated with the configured CS-RNTI identified by the cs-RNTI-id-rXX in the same SPS-Config.
cs-RNTI-id-rXX configures the ID of associated CS-RNTI for the SPS-Config. When the DCI is scrambled with the CS-RNTI identified by cs-RNTI-id-rXX, the SPS-Config with the SPS-ConfigIndex-rXX signaled in the DCI shall be addressed for activation/release/retransmission. Moreover, the associated CS-RNTI also corresponds to n_{RNTI} in 3GPP TS 38.211, “NR; Physical channels and modulation” (Release 16) (hereinafter TS 38.211) used for PDSCH data scrambling sequence generation.
dataScramblingIdentityPDSCH-rXX is used for determining the parameter n_{ID}∈{0,1, . . . , 1023} in 3GPP TS 38.211, “NR; Physical channels and modulation (Release 16)” (hereinafter “TS 38.211 Rel. 16) used for PDSCH data scrambling sequence generation based on the procedure specified in TS 38.211 Rel. 16.
dataScramblingIdentityPDSCH2-rXX is also used for determining the parameter n_{ID}∈{0,1, . . . , 1023} in TS 38.211 Rel. 16 used for PDSCH data scrambling sequence generation based on the procedure specified in TS 38.211 Rel. 16.
dmrs-Config-rXX is defined as type DMRS-DownlinkConfig TS 38.331 Rel. 16, and configures all the required parameters used for DMRS generation in TS 38.211 Rel. 16.

PDSCH data scrambling and DMRS generation can be obtained according to the methods in TS 38.211 Rel. 16 by using the parameters configured in the respective SPS-Config when DCI is scrambled with any CS-RNTI configured by using the first embodiment described above.

The proposed embodiments one and two above enable NR to support multicast/groupcast transmission for periodic traffic. Specifically, the proposed multiple CS-RNTI configurations enable UE to support both unicast and several multicast/groupcast transmission for periodic traffic flows corresponding to different multicast groups. Such multiple casting group support can be used for grouping UEs according to the subscription of the multicast message as well as the commonality of radio link quality of involved UEs. As a result, the overall system spectrum efficiency can be significantly improved by the additional degree of freedom for radio resource utilization.

Enhanced HARQ-ACK Feedback

This disclosure provides the following embodiments to support enhanced HARQ-ACK feedback for multicast periodic traffic transmission:

### Embodiment 1: Enhanced HARQ-ACK Feedback Type for SPS Transmission

In this embodiment, HARQ-ACK feedback for SPS unicast or multicast/groupcast transmission can be enhanced to support two types of feedback: 1) ACK or NACK feedback; and 2) only NACK feedback. For type-1 HARQ-ACK feedback, UE shall report ACK or NACK in the PUCCH resource depending on whether the transmitted transport block (TB) in the PDSCH is correctly received or not. For type-2 HARQ-ACK feedback, UE shall only report NACK when the transmitted TB in the PDSCH is not correctly received, and skip the HARQ-ACK feedback if the transmitted TB is correctly received. In case of type-1 HARQ-ACK feedback for SPS multicast transmission, different UEs in the multicast group may be configured with different or non-overlapped PUCCH resources for HARQ-ACK feedback, and gNB can schedule retransmission of SPS PDSCH for one or more individual UEs by using unicast PDSCH based on the HARQ-ACK feedback of the one or more individual UEs. In case of type-2 HARQ-ACK feedback for SPS multicast transmission, different UEs in the multicast group may be configured with same PUCCH resource for HARQ-ACK feedback, and, upon the reception of NACK, gNB can schedule a retransmission of PDSCH by using multicast CS-RNTI. To realize this function, RRC information element (IE) SPS-Config in 3GPP TS 38.331, v16.0.0, “NR; Radio Resource Control (RRC) Protocol Specification,” (2020-04-06) (hereinafter TS 38.331 v.16.0.00).

can be enhanced as follows:

```
SPS-Config ::=  SEQUENCE {
  ...,
  [[
  harq-ACK-Type-rXX ENUMERATED {ACK-NACK, NACK-Only}
  ]]
}
```

Where
Parameter harq-ACK-Type-rXX configures the HARQ-ACK feedback type, it includes two possible values:
   ACK-NACK: either ACK or NACK shall be reported by UE depending on whether received PDSCH is correct or not.
   NACK-only: UE only reports NACK when TB transmitted by PDSCH is not correctly received.

When type-2 HARQ-ACK feedback is configured, UE does not transmit ACK feedback when the TB is correctly received. The latter can lead to an improved power consumption. For a groupcast message which is critical to all the intended UEs in the group, if any UE in the group does not correctly receive the groupcast message, gNB needs to retransmit the message. In this case, it would be efficient to have all the UEs in the group configured by the gNB with the same PUCCH resource and type-2 HARQ-ACK. With all UEs sharing the same PUCCH resource, this also significantly reduces the PUCCH resource allocation and increase the UL radio resource efficiency.

For some groupcast service, it may be desired for gNB to detect the reception status of each involved UE. For example, this may enable gNB to determine the casting group based on the UE link quality. Specifically, those UEs with similar link quality can be arranged in the same multicast group, so that the modulation coding scheme can be more optimally selected for the group. In this case, it would be beneficial to configure type-1 HARQ-ACK for UEs in the multicast group.

### Embodiment-2: Configurable HARQ-ACK Type for SPS Transmission

In this embodiment, either semi-static or dynamic HARQ-ACK feedback type can be configured by RRC signaling for SPS transmission. In case of semi-static configuration, the HACK-ACK feedback type can be explicitly configured in SPS-Config (TS 38.331 v.16.0.00) as in Embodiment-1. In case of dynamic configuration, the HARQ-ACK feedback type can be dynamically signaled in the SPS activation DCI either by using a new bit field in the part of PUCCH resource indicator.

In this embodiment, either semi-static or dynamic HARQ-ACK feedback type can be configured by RRC signaling for SPS transmission. In case of semi-static configuration, the HACK-ACK feedback type can be explicitly configured in SPS-Config (TS 38.331 v.16.0.00) as in Embodiment-1 immediately above. In case of dynamic configuration, the HARQ-ACK feedback type can be dynamically signaled in the SPS activation DCI by using a new bit field in the part of PUCCH resource indicator. This can be realized by using the following enhanced SPS-Config (TS 38.331 v.16.0.00) as follows:

```
SPS-Config ::=  SEQUENCE {
  ...,
  [[
    harq-ACK-Type-rXX CHOICE [
        semi-static NUMERATED {ACK-NACK, NACK-Only}
      dynamic
    }
  ]]
}
```

where
Parameter harq-ACK-Type-rXX configures the HARQ-ACK feedback type to be either semi-static or dynamic signaled.
   When it is set to “semi-static”, either ACK-NACK or NACK-only HARQ-ACK feedback shall be used by the UE.
   When it is set to “dynamic”, a new bit field, e.g., the first bit of DCI field PUCCH resource indicator, can be used to signal either ACK-NACK or NACK-only HARQ-ACK feedback shall be used. The bit field indicating the HARQ-ACK type can be set as follows:
      0: ACK-NACK HARQ-ACK feedback is used
      1: NACK-only HARQ-ACK feedback is used.

### Embodiment-3: PUCCH Resource Enhancement to Support NACK Only Feedback

In this embodiment, PUCCH resource can be enhanced to support either ACK-NACK or NACK-only transmission when it is configured with PUCCH format 0 or 1 for HARQ-ACK feedback. Specifically, when a PUCCH resource configured as “ACK-NACK” resource and chosen by the PUCCH resource indicator field in the DCI, ACK-NACK feedback shall be generated by UE for the HARQ-ACK response to the received PDSCH. On the other hand, when a PUCCH resource configured as “NACK-only” resource and chosen by the PUCCH resource indicator field in the DCI, UE shall only transmit NACK as HARQ-ACK feedback when the received PDSCH is not correctly decoded, or nothing otherwise.

According to this third embodiment, PUCCH resource can be enhanced to support either ACK-NACK or NACK-only transmission when it is configured with PUCCH format 0 or 1 for HARQ-ACK feedback. Specifically, when a PUCCH resource is configured as “ACK-NACK” resource and chosen by the PUCCH resource indicator field in the DCI, ACK-NACK feedback shall be generated by UE for the HARQ-ACK response to the received PDSCH. On the other hand, when a PUCCH resource is configured as “NACK-only” resource and chosen by the PUCCH resource indicator field in the DCI, UE shall only transmit NACK as HARQ-ACK feedback when the received PDSCH is not correctly decoded, or nothing otherwise. The PUCCH-Resource in (TS 38.331 v.16.0.00) can be enhanced as follows:

```
PUCCH-Resource ::=  SEQUENCE {
  ......
  [[
  harq-ACK-Type-rXX ENUMERATED {ACK-NACK, NACK-Only}
    ......
}
```

Where
Parameter harq-ACK-Type-rXX configures the HARQ-ACK feedback type, it includes two possible values:
   ACK-NACK: either ACK or NACK shall be reported by UE depending on whether received PDSCH is correctly decoded or not.
   NACK-only: UE only reports NACK when TB transmitted by PDSCH is not correctly received.

With the third embodiment, NACK-only HARQ-ACK response can be configured per PUCCH resource, and PUCCH resource can be chosen for any PDSCH transmission which can be scheduled for aperiodic or periodic transmission with unicast or multicast messages. Moreover, based on HARQ-ACK feedback type, each PUCCH resource with format 0 or 1 can be allocated with proper radio resources according to the desired coverage of the PUCCH transmission. Specifically, due to the fact that with same sequence length, NACK-only PUCCH has a worse coverage than ACK-NACK PUCCH, to achieve same coverage, NACK-only PUCCH shall be allocated with more radio resources, e.g., longer sequence length, than ACK-NACK PUCCH.

The proposed embodiments enable NR to support different HARQ-ACK types e.g., ACK-NACK and NACK-Only, for multicast periodic transmission. Specifically, both semi-static and dynamic HARQ-ACK feedback type signaling are proposed. Moreover, HARQ-ACK feedback type can be configured on SPS-Config (TS 38.331 v.16.0.00) or PUCCH resource level, which enables the NACK-only HARQ-ACK feedback to be supported for unicast in addition to multicast transmission. With these proposed embodiments, UE PUCCH resources for multicast periodic traffic transmission can be optimally allocated according to the service QoS as well as radio link quality of each individual UE. As a result, the overall system spectrum and energy efficiency can be considerably improved.

### Systems and Implementations

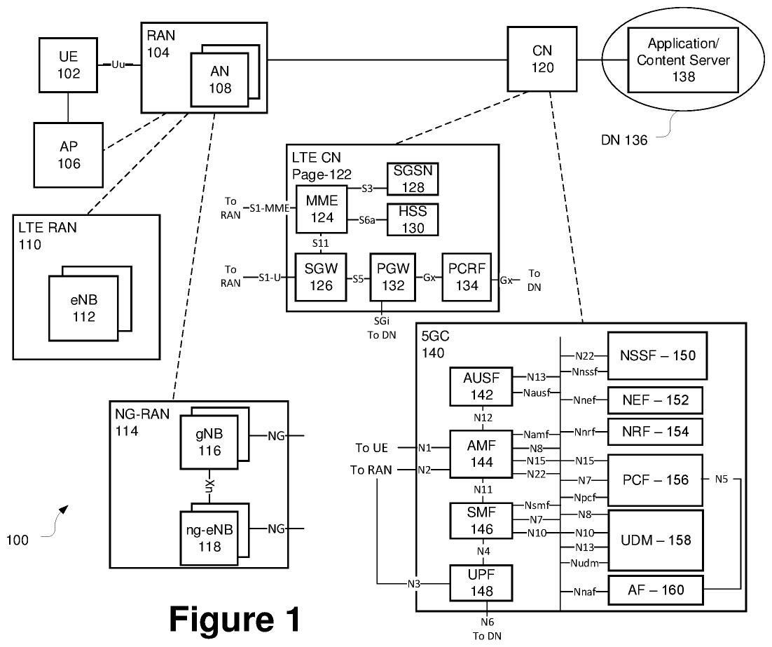

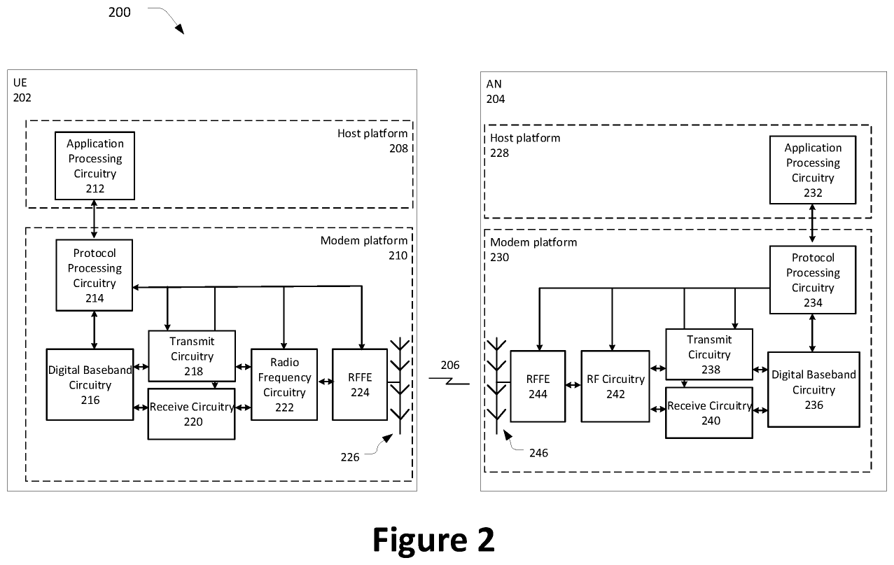

FIGS. 1-2 illustrate various systems, devices, and components that may implement aspects of disclosed embodiments.

FIG. 1 illustrates a network 100 in accordance with various embodiments. The network 100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 100 may include a UE 102, which may include any mobile or non-mobile computing device designed to communicate with a RAN 104 via an over-the-air connection. The UE 102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102 may additionally communicate with an AP 106 via an over-the-air connection. The AP 106 may manage a WLAN connection, which may serve to offload some/all network traffic from the RAN 104. The connection between the UE 102 and the AP 106 may be consistent with any IEEE 802.11 protocol, wherein the AP 106 could be a wireless fidelity (Wi-Fi®) router. In some embodiments, the UE 102, RAN 104, and AP 106 may utilize cellular-WLAN aggregation (for example, LWA/LWIP). Cellular-WLAN aggregation may involve the UE 102 being configured by the RAN 104 to utilize both cellular radio resources and WLAN resources.

The RAN 104 may include one or more access nodes, for example, AN 108. AN 108 may terminate air-interface protocols for the UE 102 by providing access stratum protocols including RRC, PDCP, RLC, MAC, and L1 protocols. In this manner, the AN 108 may enable data/voice connectivity between CN 120 and the UE 102. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102 with an air interface for network access. The UE 102 may be simultaneously connected with a plurality of cells provided by the same or different ANs of the RAN 104. For example, the UE 102 and RAN 104 may use carrier aggregation to allow the UE 102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102 or AN 108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102 can be configured with multiple BWPs where each BWP configuration has a different SCS. When a BWP change is indicated to the UE 102, the SCS of the transmission is changed as well. Another use case example of BWP is related to power saving. In particular, multiple BWPs can be configured for the UE 102 with different amount of frequency resources (for example, PRBs) to support data transmission under different traffic loading scenarios. A BWP containing a smaller number of PRBs can be used for data transmission with small traffic load while allowing power saving at the UE 102 and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102 to facilitate paging, bearer activation/deactivation, handovers, gateway selection, authentication, etc.

The SGW 126 may terminate an S1 interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102 and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102 and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102 and the RAN 104 and to subscribe to notifications about mobility events with respect to the UE 102. The AMF 144 may be responsible for registration management (for example, for registering UE 102), connection management, reachability management, mobility management, lawful interception of AMF-related events, and access authentication and authorization. The AMF 144 may provide transport for SM messages between the UE 102 and the SMF 146, and act as a transparent proxy for routing SM messages. AMF 144 may also provide transport for SMS messages between UE 102 and an SMSF. AMF YX44 may interact with the AUSF 142 and the UE 102 to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102 over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102 and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102. The NSSF 150 may also determine allowed NSSAI and the mapping to the subscribed S-NSSAIs, if needed. The NSSF 150 may also determine the AMF set to be used to serve the UE 102, or a list of candidate AMFs based on a suitable configuration and possibly by querying the NRF 154. The selection of a set of network slice instances for the UE 102 may be triggered by the AMF 144 with which the UE 102 is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR 221 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3rd party services to be geographically close to a point that the UE 102 is attached to the network. This may reduce latency and load on the network. To provide edge-computing implementations, the 5GC 140 may select a UPF 148 close to the UE YX02 and execute traffic steering from the UPF 148 to data network 136 via the N6 interface. This may be based on the UE subscription data, UE location, and information provided by the AF 160. In this way, the AF 160 may influence UPF (re)selection and traffic routing. Based on operator deployment, when AF 160 is considered to be a trusted entity, the network operator may permit AF 160 to interact directly with relevant NFs. Additionally, the AF 160 may exhibit an Naf service-based interface.

The data network 136 may represent various network operator services, Internet access, or third party services that may be provided by one or more servers including, for example, application/content server 138.

FIG. 2 schematically illustrates a wireless network 200 in accordance with various embodiments. The wireless network 200 may include a UE 202 in wireless communication with an AN 204. The UE 202 and AN 204 may be similar to, and substantially interchangeable with, like-named components described elsewhere herein.

The UE 202 may be communicatively coupled with the AN 204 via connection 206. The connection 206 is illustrated as an air interface to enable communicative coupling, and can be consistent with cellular communications protocols such as an LTE protocol or a 5G NR protocol operating at mmWave or sub-6 GHz frequencies.

The UE 202 may include a host platform 208 coupled with a modem platform 210. The host platform 208 may include application processing circuitry 212, which may be coupled with protocol processing circuitry 214 of the modem platform 210. The application processing circuitry 212 may run various applications for the UE 202 that source/sink application data. The application processing circuitry 212 may further implement one or more layer operations to transmit/receive application data to/from a data network. These layer operations may include transport (for example UDP) and Internet (for example, IP) operations

The protocol processing circuitry 214 may implement one or more of layer operations to facilitate transmission or reception of data over the connection 206. The layer operations implemented by the protocol processing circuitry 214 may include, for example, MAC, RLC, PDCP, RRC and NAS operations.

The modem platform 210 may further include digital baseband circuitry 216 that may implement one or more layer operations that are “below” layer operations performed by the protocol processing circuitry 214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 210 may further include transmit circuitry 218, receive circuitry 220, RF circuitry 222, and RF front end (RFFE) 224, which may include or connect to one or more antenna panels 226. Briefly, the transmit circuitry 218 may include a digital-to-analog converter, mixer, intermediate frequency (IF) components, etc.; the receive circuitry 220 may include an analog-to-digital converter, mixer, IF components, etc.; the RF circuitry 222 may include a low-noise amplifier, a power amplifier, power tracking components, etc.; RFFE 224 may include filters (for example, surface/bulk acoustic wave filters), switches, antenna tuners, beamforming components (for example, phase-array antenna components), etc. The selection and arrangement of the components of the transmit circuitry 218, receive circuitry 220, RF circuitry 222, RFFE 224, and antenna panels 226 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 214 may include one or more instances of control circuitry (not shown) to provide control functions for the transmit/receive components.

A UE reception may be established by and via the antenna panels 226, RFFE 224, RF circuitry 222, receive circuitry 220, digital baseband circuitry 216, and protocol processing circuitry 214. In some embodiments, the antenna panels 226 may receive a transmission from the AN 204 by receive-beamforming signals received by a plurality of antennas/antenna elements of the one or more antenna panels 226.

A UE transmission may be established by and via the protocol processing circuitry 214, digital baseband circuitry 216, transmit circuitry 218, RF circuitry 222, RFFE 224, and antenna panels 226. In some embodiments, the transmit components of the UE 204 may apply a spatial filter to the data to be transmitted to form a transmit beam emitted by the antenna elements of the antenna panels 226.

Similar to the UE 202, the AN 204 may include a host platform 228 coupled with a modem platform 230. The host platform 228 may include application processing circuitry 232 coupled with protocol processing circuitry 234 of the modem platform 230. The modem platform may further include digital baseband circuitry 236, transmit circuitry 238, receive circuitry 240, RF circuitry 242, RFFE circuitry 244, and antenna panels 246. The components of the AN 204 may be similar to and substantially interchangeable with like-named components of the UE 202. In addition to performing data transmission/reception as described above, the components of the AN 208 may perform various logical functions that include, for example, RNC functions such as radio bearer management, uplink and downlink dynamic radio resource management, and data packet scheduling.

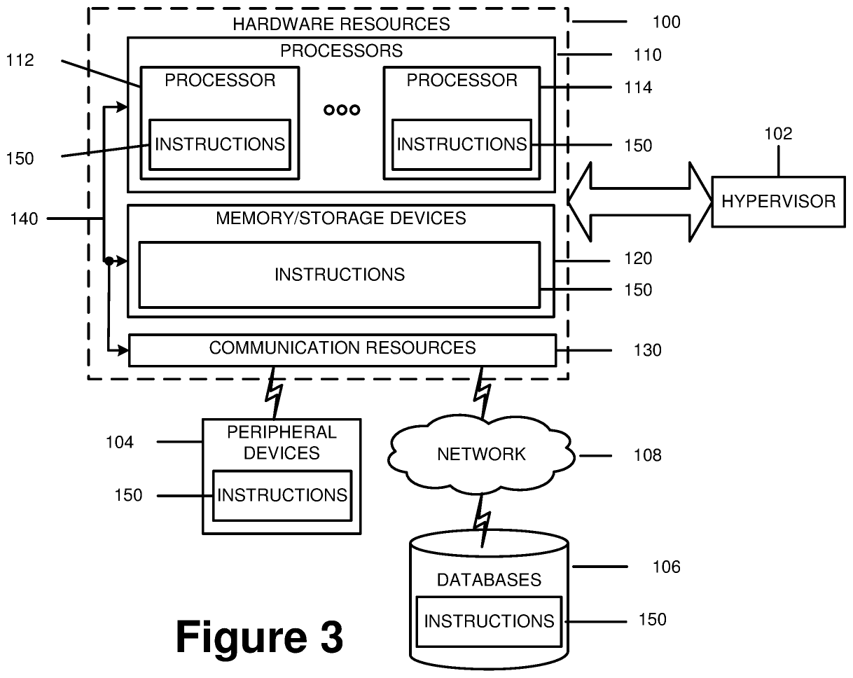

FIG. 3 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 3 shows a diagrammatic representation of hardware resources 300 including one or more processors (or processor cores) 310, one or more memory/storage devices 320, and one or more communication resources 330, each of which may be communicatively coupled via a bus 340 or other interface circuitry. For embodiments where node virtualization (e.g., NFV) is utilized, a hypervisor 302 may be executed to provide an execution environment for one or more network slices/sub-slices to utilize the hardware resources 300.

The processors 310 may include, for example, a processor 312 and a processor 314. The processors 310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 320 may include main memory, disk storage, or any suitable combination thereof. The memory/storage devices 320 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 330 may include interconnection or network interface controllers, components, or other suitable devices to communicate with one or more peripheral devices 304 or one or more databases 306 or other network elements via a network 308. For example, the communication resources 330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 350 may comprise software, a program, an application, an applet, an app, or other executable code for causing at least any of the processors 310 to perform any one or more of the methodologies discussed herein. The instructions 350 may reside, completely or partially, within at least one of the processors 310 (e.g., within the processor's cache memory), the memory/storage devices 320, or any suitable combination thereof. Furthermore, any portion of the instructions 350 may be transferred to the hardware resources 300 from any combination of the peripheral devices 304 or the databases 306. Accordingly, the memory of processors 310, the memory/storage devices 320, the peripheral devices 304, and the databases 306 are examples of computer-readable and machine-readable media.

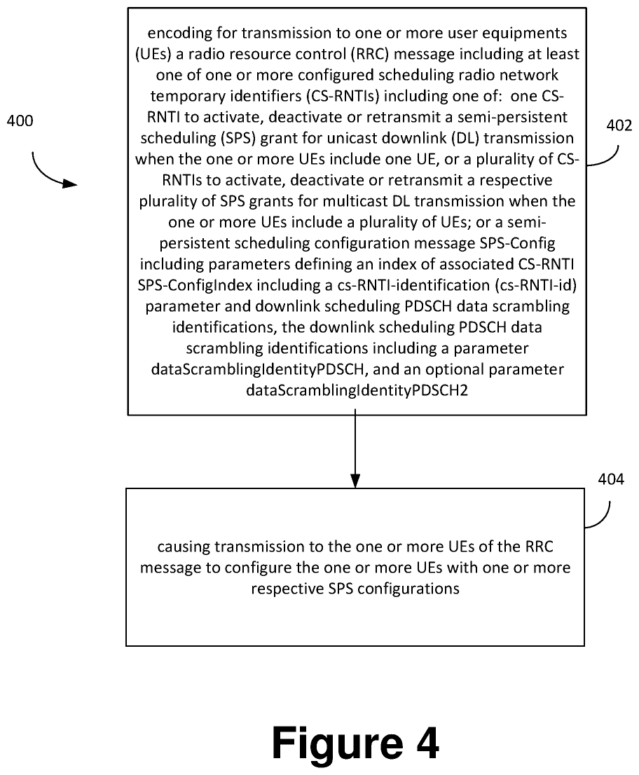

FIG. 4 includes a flow chart of a process 400 according to a first embodiment. At operation 402, the process includes encoding for transmission to one or more user equipments (UEs) a radio resource control (RRC) message including at least one of one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2. At operation 404, the process includes causing transmission to the one or more UEs of the RRC message to configure the one or more UEs with one or more respective SPS configurations.

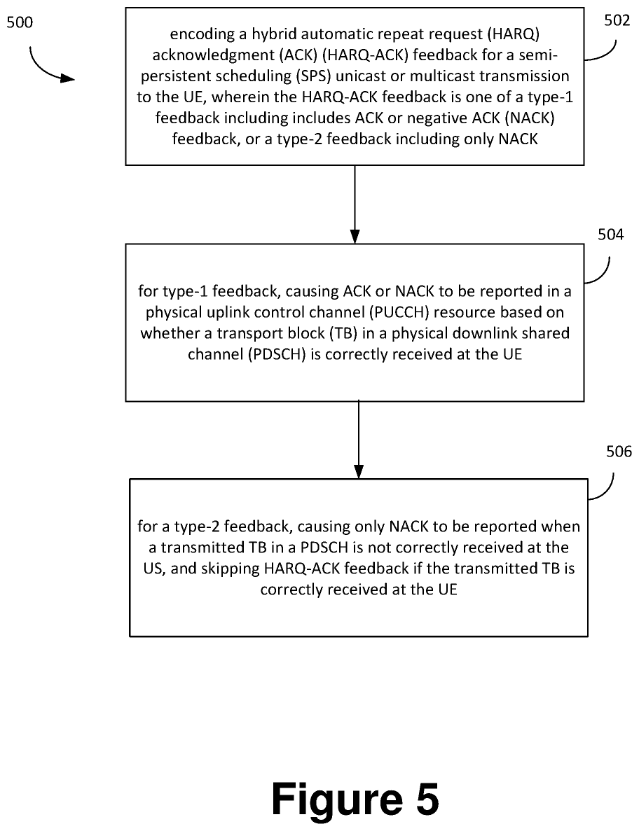

FIG. 5 includes a flow chart of a process 500 according to a second embodiment. At operation 502, the process includes encoding a hybrid automatic repeat request (HARQ) acknowledgment (ACK) (HARQ-ACK) feedback for a semi-persistent scheduling (SPS) unicast or multicast transmission to the UE, wherein the HARQ-ACK feedback is one of a type-1 feedback including includes ACK or negative ACK (NACK) feedback, or a type-2 feedback including only NACK; at process 504, the process includes, for type-1 feedback, causing ACK or NACK to be reported in a physical uplink control channel (PUCCH) resource based on whether a transport block (TB) in a physical downlink shared channel (PDSCH) is correctly received at the UE; at process 506, the process includes, for a type-2 feedback, causing only NACK to be reported when a transmitted TB in a PDSCH is not correctly received at the US, and skipping HARQ-ACK feedback if the transmitted TB is correctly received at the UE.

In some embodiments, the electronic device(s), network(s), system(s), chip(s) or component(s), or portions or implementations thereof, of the figures herein, may be configured to perform one or more processes, techniques, or methods as described herein, or portions thereof. Examples of such processes are depicted in FIGS. 4 and 5.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 includes an apparatus of a New Radio (NR) evolved Node B (gNB), the apparatus including one or more processing circuitries including a digital baseband processing circuitry, and a protocol processing circuitry coupled to the digital baseband processing circuitry, the one or more circuitries to: encode for transmission to one or more user equipments (UEs) a radio resource control (RRC) message including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and cause transmission to the one or more UEs of the RRC message to configure the one or more UEs with one or more respective SPS configurations.

Example 2 includes the subject matter of Example 1, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 3 includes the subject matter of Example 2, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 4 includes the subject matter of Example 3, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

Example 5 includes the subject matter of Example 3, wherein, when the RRC message includes the one or more CS-RNTIs, the RRC message includes a parameter maxNrofCS-RNTI specifying a maximum number of CS-RNTI supported.

Example 6 includes the subject matter of Example 3, the cs-RNTIList defines a list of the one or more CS-RNTIs being configured to the one or more UEs for the physical cell group, each CS-RNT value in the list corresponding to one of a unicast type, a multicast/groupcast type, or a broadcast type.

Example 7 includes the subject matter of Example 1, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 8 includes the subject matter of Example 7, wherein the one or more UEs are to be part of a serving cell including multiple groupcast groups of UEs, each group of the multiple groups containing either non-overlapped UEs or a partially overlapped set of UEs.

Example 9 includes the subject matter of Example 8, wherein the plurality of CS-RNTIs includes a same CS-RNTI value to correspond to all UEs in a same group of the multiple groupcast groups of UEs.

Example 10 includes the subject matter of Example 8, wherein the plurality of CS-RNTIs includes different CS-RNTI values to configure a same UE of the one or more UEs based on a number of groups of the multiple groupcast groups that the same UE belongs to.

Example 11 includes the subject matter of Example 1, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 12 includes the subject matter of Example 2, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 13 includes the subject matter of Example 12, wherein the SPS-ConfigIndex parameter includes include parameter sps-ConfigIndex-rXX, wherein XX corresponds to a number larger than 16.

Example 14 includes the subject matter of Example 13, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 15 includes the subject matter of Example 12, wherein the one or more circuitries are to scramble a downlink control information message (DCI) with CS-RNTI identified by cs-RNTI-id-rXX, the SPS-Config with the sps-ConfigIndex-rXX is signaled in the DCI and is addressed for activation/release/retransmission.

Example 16 includes the subject matter of Example 15, wherein the CS-RNTI identified by cs-RNTI-id-rXX is associated with n_{RNTI} to generate a PDSCH data scrambling sequence.

Example 17 includes the subject matter of Example 12, wherein parameter n_{ID}∈{0,1, . . . , 1023} used for PDSCH data scrambling sequence generation is based on dataScramblingIdentityPDSCH-rXX.

Example 18 includes the subject matter of Example 12, wherein parameter n_{ID}∈{0,1, . . . , 1023} used for PDSCH data scrambling sequence generation is based dataScramblingIdentityPDSCH-rXX.

Example 19 includes the subject matter of Example 12, wherein SPS-Config includes a dmrs-Config-rXX parameter defined as type DMRS-DownlinkConfig to configures parameters for DMRS generation.

Example 20 includes the subject matter of Example 12, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 21 includes the subject matter of any one of Examples 1-20, the one or more circuitries to further process information from a core network regarding the one or more CS-RNTI or the SPS-Config, and encoding based on the information from the core network.

Example 22 includes the subject matter of any one of Examples 1-21, further including a radio front end circuitry coupled to the one or more circuitries, and one or more antennas coupled to the radio front end circuitry to transmit and receive wireless signals.

Example 23 includes a method to be performed at a New Radio (NR) evolved Node B (gNB) including: encoding for transmission to one or more user equipments (UEs) a radio resource control (RRC) message including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and causing transmission to the one or more UEs of the RRC message to configure the one or more UEs with one or more respective SPS configurations.

Example 24 includes the subject matter of Example 23, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 25 includes the subject matter of Example 24, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 26 includes the subject matter of Example 25, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

Example 27 includes the subject matter of Example 25, wherein, when the RRC message includes the one or more CS-RNTIs, the RRC message includes a parameter maxNrofCS-RNTI specifying a maximum number of CS-RNTI supported.

Example 28 includes the subject matter of Example 25, the cs-RNTIList defines a list of the one or more CS-RNTIs being configured to the one or more UEs for the physical cell group, each CS-RNT value in the list corresponding to one of a unicast type, a multicast/groupcast type, or a broadcast type.

Example 29 includes the subject matter of Example 23, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 30 includes the subject matter of Example 29, wherein the one or more UEs are part of a serving cell including multiple groupcast groups of UEs, each group of the multiple groups containing either non-overlapped UEs or a partially overlapped set of UEs.

Example 31 includes the subject matter of Example 30, wherein the plurality of CS-RNTIs includes a same CS-RNTI value to correspond to all UEs in a same group of the multiple groupcast groups of UEs.

Example 32 includes the subject matter of Example 30, wherein the plurality of CS-RNTIs includes different CS-RNTI values to configure a same UE of the one or more UEs based on a number of groups of the multiple groupcast groups that the same UE belongs to.

Example 33 includes the subject matter of Example 23, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 34 includes the subject matter of Example 24, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 35 includes the subject matter of Example 34, wherein the SPS-ConfigIndex parameter includes parameter sps-ConfigIndex-rXX, wherein XX corresponds to a number larger than 16.

Example 36 includes the subject matter of Example 35, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 37 includes the subject matter of Example 34, further including scrambling a downlink control information message (DCI) with CS-RNTI identified by cs-RNTI-id-rXX, the SPS-Config with the sps-ConfigIndex-rXX is signaled in the DCI and is addressed for activation/release/retransmission.

Example 38 includes the subject matter of Example 37, wherein the CS-RNTI identified by cs-RNTI-id-rXX is associated with n_{RNTI} to generate a PDSCH data scrambling sequence.

Example 39 includes the subject matter of Example 34, wherein parameter n_{ID}∈{0,1, . . . , 1023} used for PDSCH data scrambling sequence generation is based on dataScramblingIdentityPDSCH-rXX.

Example 40 includes the subject matter of Example 34, wherein parameter n_{ID}∈{0,1, . . . , 1023} used for PDSCH data scrambling sequence generation is based dataScramblingIdentityPDSCH-rXX.

Example 41 includes the subject matter of Example 34, wherein SPS-Config includes a dmrs-Config-rXX parameter defined as type DMRS-DownlinkConfig to configures parameters for DMRS generation.

Example 42 includes the subject matter of Example 34, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 43 includes the subject matter of any one of Examples 23-42, further including processing information from a core network regarding the one or more CS-RNTI or the SPS-Config, and encoding based on the information from the core network.

Example 44 includes a non-transitory machine-readable storage medium comprising instructions to cause an device of a New Radio (NR) evolved Node B (gNB), upon execution of the instructions by one or more circuitries of the device, to perform operations including: encoding for transmission to one or more user equipments (UEs) a radio resource control (RRC) message including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and causing transmission to the one or more UEs of the RRC message to configure the one or more UEs with one or more respective SPS configurations.

Example 45 includes the subject matter of Example 44, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 46 includes the subject matter of Example 45, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 47 includes the subject matter of Example 46, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

Example 48 includes the subject matter of Example 46, wherein, when the RRC message includes the one or more CS-RNTIs, the RRC message includes a parameter maxNrofCS-RNTI specifying a maximum number of CS-RNTI supported.

Example 49 includes the subject matter of Example 46, the cs-RNTIList defines a list of the one or more CS-RNTIs being configured to the one or more UEs for the physical cell group, each CS-RNT value in the list corresponding to one of a unicast type, a multicast/groupcast type, or a broadcast type.

Example 50 includes the subject matter of Example 44, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 51 includes the subject matter of Example 50, wherein the one or more UEs are part of a serving cell including multiple groupcast groups of UEs, each group of the multiple groups containing either non-overlapped UEs or a partially overlapped set of UEs.

Example 52 includes the subject matter of Example 51, wherein the plurality of CS-RNTIs includes a same CS-RNTI value to correspond to all UEs in a same group of the multiple groupcast groups of UEs.

Example 53 includes the subject matter of Example 51, wherein the plurality of CS-RNTIs includes different CS-RNTI values to configure a same UE of the one or more UEs based on a number of groups of the multiple groupcast groups that the same UE belongs to.

Example 54 includes the subject matter of Example 44, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 55 includes the subject matter of Example 45, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 56 includes the subject matter of Example 55, wherein the SPS-ConfigIndex parameter includes parameter sps-ConfigIndex-rXX, wherein XX corresponds to a number larger than 16.

Example 57 includes the subject matter of Example 56, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 58 includes the subject matter of Example 55, the operations further including scrambling a downlink control information message (DCI) with CS-RNTI identified by cs-RNTI-id-rXX, the SPS-Config with the sps-ConfigIndex-rXX is signaled in the DCI and is addressed for activation/release/retransmission.

Example 59 includes the subject matter of Example 58, wherein the CS-RNTI identified by cs-RNTI-id-rXX is associated with n_{RNTI} to generate a PDSCH data scrambling sequence.

Example 60 includes the subject matter of Example 56, wherein parameter n_{ID}∈{0,1, . . . , 1023} used for PDSCH data scrambling sequence generation is based on dataScramblingIdentityPDSCH-rXX.

Example 61 includes the subject matter of Example 55, wherein parameter n_{ID}∈{0,1, . . . , 1023} used for PDSCH data scrambling sequence generation is based dataScramblingIdentityPDSCH-rXX.

Example 62 includes the subject matter of Example 55, wherein SPS-Config includes a dmrs-Config-rXX parameter defined as type DMRS-DownlinkConfig to configures parameters for DMRS generation.

Example 63 includes the subject matter of Example 55, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 64 includes the subject matter of any one of claims 44-63, the operations further including processing information from a core network regarding the one or more CS-RNTI or the SPS-Config, and encoding based on the information from the core network.

Example 65 includes an apparatus of a New Radio (NR) User Equipment (UE), the apparatus including one or more processing circuitries including a digital baseband processing circuitry, and a protocol processing circuitry coupled to the digital baseband processing circuitry, the one or more circuitries to: decode a radio resource control (RRC) message from a NR evolved Node B (gNB) including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission to the UE, or a plurality of CS-RNTIs to activate, deactivate or retransmit a respective plurality of SPS grants for multicast DL transmission to a plurality of UEs including the UE; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; configure the UE with a SPS configuration based on the RRC message; and receive a DL transmission from the gNB based on the SPS configuration.

Example 66 includes the subject matter of Example 65, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 67 includes the subject matter of Example 66, wherein, when the RRC message includes the one or more CS-RNTIs, the RRC message includes a RRC information element (IE) to configure a physical cell group including the plurality of UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 68 includes the subject matter of Example 67, wherein, when the RRC message includes the one or more CS-RNTIs, the RRC message includes a cs-RNTI-identification (cs-RNTI-id) parameter, cs-RNTI-id, and an index of the CS-RNTI configured for the UE is used to identify respective RNTIs in other RRC configuration information elements (IEs).

Example 69 includes the subject matter of Example 67, wherein, when the RRC message includes the one or more CS-RNTIs, the RRC message includes a parameter maxNrofCS-RNTI specifying a maximum number of CS-RNTI supported.

Example 70 includes the subject matter of Example 67, the cs-RNTIList defines a list of the one or more CS-RNTIs being configured to the plurality of UEs for the physical cell group, each CS-RNT value in the list corresponding to one of a unicast type, a multicast/groupcast type, or a broadcast type.

Example 71 includes the subject matter of Example 65, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 72 includes the subject matter of Example 71, wherein the UE is to be part of a serving cell including multiple groupcast groups of UEs, each group of the multiple groups containing either non-overlapped UEs or a partially overlapped set of UEs.

Example 73 includes the subject matter of Example 72, wherein the plurality of CS-RNTIs includes a same CS-RNTI value to correspond to all UEs in a same group of the multiple groupcast groups of UEs.

Example 74 includes the subject matter of Example 72, wherein the plurality of CS-RNTIs includes different CS-RNTI values to configure the UE based on a number of groups of the multiple groupcast groups that the UE belongs to.

Example 75 includes the subject matter of Example 65, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 76 includes the subject matter of Example 66, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 77 includes the subject matter of Example 76, wherein the SPS-ConfigIndex parameter includes include parameter sps-ConfigIndex-rXX, wherein XX corresponds to a number larger than 16.

Example 78 includes the subject matter of Example 77, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 79 includes the subject matter of Example 76, the one or more circuitries to decode a downlink control information message (DCI) from the gNB, the DCI scrambled with CS-RNTI identified by cs-RNTI-id-rXX, the SPS-Config with the sps-ConfigIndex-rXX is signaled in the DCI and is addressed for activation/release/retransmission.

Example 80 includes the subject matter of Example 79, wherein the CS-RNTI identified by cs-RNTI-id-rXX is associated with n_{RNTI} to generate a PDSCH data scrambling sequence.

Example 81 includes the subject matter of Example 76, wherein parameter n_{ID}∈{0,1, . . . , 1023} used for PDSCH data scrambling sequence generation is based on dataScramblingIdentityPDSCH-rXX.

Example 82 includes the subject matter of Example 76, wherein parameter n_{ID}∈{0,1, . . . , 1023} used for PDSCH data scrambling sequence generation is based dataScramblingIdentityPDSCH-rXX.

Example 83 includes the subject matter of Example 76, wherein SPS-Config includes a dmrs-Config-rXX parameter defined as type DMRS-DownlinkConfig to configures parameters for DMRS generation.

Example 84 includes the subject matter of Example 76, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 85 includes the subject matter of any one of Examples 65-84, further including a radio front end circuitry coupled to the one or more circuitries, and one or more antennas coupled to the radio front end circuitry to transmit and receive wireless signals.

Example 86 includes a method to be performed at an apparatus of a New Radio (NR) User Equipment (UE), the method including: decoding a radio resource control (RRC) message from a NR evolved Node B (gNB) including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission to the UE, or a plurality of CS-RNTIs to activate, deactivate or retransmit a respective plurality of SPS grants for multicast DL transmission to a plurality of UEs including the UE; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; configuring the UE with a SPS configuration based on the RRC message; and receiving a DL transmission from the gNB based on the SPS configuration.

Example 87 includes the subject matter of Example 86, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 88 includes the subject matter of Example 87, wherein, when the RRC message includes the one or more CS-RNTIs, the RRC message includes a RRC information element (IE) to configure a physical cell group including the plurality of UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 89 includes the subject matter of Example 88, wherein, when the RRC message includes the one or more CS-RNTIs, the RRC message includes a cs-RNTI-identification (cs-RNTI-id) parameter, cs-RNTI-id, and an index of the CS-RNTI configured for the UE is used to identify respective RNTIs in other RRC configuration information elements (IEs).

Example 90 includes the subject matter of Example 88, wherein, when the RRC message includes the one or more CS-RNTIs, the RRC message includes a parameter maxNrofCS-RNTI specifying a maximum number of CS-RNTI supported.

Example 91 includes the subject matter of Example 88, the cs-RNTIList defines a list of the one or more CS-RNTIs being configured to the plurality of UEs for the physical cell group, each CS-RNT value in the list corresponding to one of a unicast type, a multicast/groupcast type, or a broadcast type.

Example 92 includes the subject matter of Example 86, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 93 includes the subject matter of Example 92, wherein the UE is to be part of a serving cell including multiple groupcast groups of UEs, each group of the multiple groups containing either non-overlapped UEs or a partially overlapped set of UEs.

Example 94 includes the subject matter of Example 93, wherein the plurality of CS-RNTIs includes a same CS-RNTI value to correspond to all UEs in a same group of the multiple groupcast groups of UEs.

Example 95 includes the subject matter of Example 93, wherein the plurality of CS-RNTIs includes different CS-RNTI values to configure the UE based on a number of groups of the multiple groupcast groups that the UE belongs to.

Example 96 includes the subject matter of Example 86, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 97 includes the subject matter of Example 87, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 98 includes the subject matter of Example 97, wherein the SPS-ConfigIndex parameter includes include parameter sps-ConfigIndex-rXX, wherein XX corresponds to a number larger than 16.

Example 99 includes the subject matter of Example 98, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 100 includes the subject matter of Example 97, further including decoding a downlink control information message (DCI) from the gNB, the DCI scrambled with CS-RNTI identified by cs-RNTI-id-rXX, the SPS-Config with the sps-ConfigIndex-rXX is signaled in the DCI and is addressed for activation/release/retransmission.

Example 101 includes the subject matter of Example 100, wherein the CS-RNTI identified by cs-RNTI-id-rXX is associated with n_{RNTI} to generate a PDSCH data scrambling sequence.

Example 102 includes the subject matter of Example 97, wherein parameter n_{ID}∈{0,1, . . . , 1023} used for PDSCH data scrambling sequence generation is based on dataScramblingIdentityPDSCH-rXX.

Example 103 includes the subject matter of Example 97, wherein parameter n_{ID}∈{0,1, . . . , 1023} used for PDSCH data scrambling sequence generation is based dataScramblingIdentityPDSCH-rXX.

Example 104 includes the subject matter of Example 97, wherein SPS-Config includes a dmrs-Config-rXX parameter defined as type DMRS-DownlinkConfig to configures parameters for DMRS generation.

Example 105 includes the subject matter of Example 97, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 106 includes a non-transitory machine-readable storage medium comprising instructions to cause an device of a New Radio (NR) User Equipment (UE), upon execution of the instructions by one or more circuitries of the device, to perform operations including: decoding a radio resource control (RRC) message from a NR evolved Node B (gNB) including at least one of: one or more configured scheduling radio network temporary identifiers (CS-RNTIs) including one of: one CS-RNTI to activate, deactivate or retransmit a semi-persistent scheduling (SPS) grant for unicast downlink (DL) transmission to the UE, or a plurality of CS-RNTIs to activate, deactivate or retransmit a respective plurality of SPS grants for multicast DL transmission to a plurality of UEs including the UE; or a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; configuring the UE with a SPS configuration based on the RRC message; and receiving a DL transmission from the gNB based on the SPS configuration.

Example 107 includes the subject matter of Example 106, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

Example 108 includes the subject matter of Example 107, wherein, when the RRC message includes the one or more CS-RNTIs, the RRC message includes a RRC information element (IE) to configure a physical cell group including the plurality of UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

Example 109 includes the subject matter of Example 108, wherein, when the RRC message includes the one or more CS-RNTIs, the RRC message includes a cs-RNTI-identification (cs-RNTI-id) parameter, cs-RNTI-id, and an index of the CS-RNTI configured for the UE is used to identify respective RNTIs in other RRC configuration information elements (IEs).

Example 110 includes the subject matter of Example 108, wherein, when the RRC message includes the one or more CS-RNTIs, the RRC message includes a parameter maxNrofCS-RNTI specifying a maximum number of CS-RNTI supported.

Example 111 includes the subject matter of Example 108, the cs-RNTIList defines a list of the one or more CS-RNTIs being configured to the plurality of UEs for the physical cell group, each CS-RNT value in the list corresponding to one of a unicast type, a multicast/groupcast type, or a broadcast type.

Example 112 includes the subject matter of Example 106, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs.

Example 113 includes the subject matter of Example 112, wherein the UE is to be part of a serving cell including multiple groupcast groups of UEs, each group of the multiple groups containing either non-overlapped UEs or a partially overlapped set of UEs.

Example 114 includes the subject matter of Example 113, wherein the plurality of CS-RNTIs includes a same CS-RNTI value to correspond to all UEs in a same group of the multiple groupcast groups of UEs.

Example 115 includes the subject matter of Example 113, wherein the plurality of CS-RNTIs includes different CS-RNTI values to configure the UE based on a number of groups of the multiple groupcast groups that the UE belongs to.

Example 116 includes the subject matter of Example 106, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

Example 117 includes the subject matter of Example 106, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

Example 118 includes the subject matter of Example 117, wherein the SPS-ConfigIndex parameter includes include parameter sps-ConfigIndex-rXX, wherein XX corresponds to a number larger than 16.

Example 119 includes the subject matter of Example 118, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

Example 120 includes the subject matter of Example 117, the operations further including decoding a downlink control information message (DCI) from the gNB, the DCI scrambled with CS-RNTI identified by cs-RNTI-id-rXX, the SPS-Config with the sps-ConfigIndex-rXX is signaled in the DCI and is addressed for activation/release/retransmission.

Example 121 includes the subject matter of Example 120, wherein the CS-RNTI identified by cs-RNTI-id-rXX is associated with n_{RNTI} to generate a PDSCH data scrambling sequence.

Example 122 includes the subject matter of Example 117, wherein parameter n_{ID}∈{0,1, . . . , 1023} used for PDSCH data scrambling sequence generation is based on dataScramblingIdentityPDSCH-rXX.

Example 123 includes the subject matter of Example 117, wherein parameter n_{ID}∈{0,1, . . . , 1023} used for PDSCH data scrambling sequence generation is based dataScramblingIdentityPDSCH-rXX.

Example 124 includes the subject matter of Example 117, wherein SPS-Config includes a dmrs-Config-rXX parameter defined as type DMRS-DownlinkConfig to configures parameters for DMRS generation.

Example 125 includes the subject matter of Example 117, wherein, when the RRC message includes the one or more CS-RNTIs, and downlink control information (DCI) is scrambled with CS-RNTI, parameters configured in SPS-Config are to be used to determine PDSCH data scrambling and demodulation reference signal (DMRS) generation.

Example 126 includes a method of transmitting, receiving, processing, or encoding enhanced HARQ-ACK feedback for SPS unicast or multicast/groupcast transmission.

Example 127 includes the method of Example 126 or some other Example herein, wherein the enhanced HARQ-ACK feedback is a type-1 feedback, which includes ACK or NACK feedback, or a type-2 feedback, which only includes NACK.

Example 128 includes the method of Example 127 or some other Example herein, wherein for type-1 feedback, a UE is to report ACK or NACK in a PUCCH resource depending on whether a transmitted transport block (TB) in a PDSCH is correctly received or not.

Example 129 includes the method of Example 127 or some other Example herein, wherein for type-2 feedback, a UE is to only report NACK when a transmitted TB in a PDSCH is not correctly received, and is to skip HARQ-ACK feedback if the transmitted TB is correctly received.

Example 130 includes the method of Example 127 or some other Example herein, wherein for type-1 feedback for SPS multicast transmission, different UEs in a multicast group may be configured with non-overlapped PUCCH resources for HARQ-ACK feedback, and a gNB can schedule retransmission of SPS PDSCH for individual UE by using unicast PDSCH based on HARQ-ACK feedback of an individual UE.

Example 131 includes the method of Example 127 or some other Example herein, wherein for type-2 feedback for SPS multicast transmission, different UEs in a multicast group may be configured with same PUCCH resource for HARQ-ACK feedback, and, upon reception of NACK, a gNB can schedule a retransmission of PDSCH by using multicast CS-RNTI.

Example 132 includes the method of Example 127 or some other Example herein, wherein the method comprises encoding or processing an RRC information element (IE) SPS-Config to configure a UE for enhanced HARQ-ACK feedback, wherein the RRC IE is defined as:

SPS-Config ::= SEQUENCE {
...,
[[
harq-ACK-Type-rXX ENUMERATED {ACK-NACK, NACK-Only}
]]
},

wherein “rXX” may be replaced with a release version of associated Technical Specification; ACK-NACK is to configure the UE for type-1 feedback; and NACK-Only is to configure the UE for type-2 feedback.

Example 133 includes the method of Example 132 or some other Example herein, wherein parameter harq-ACK-Type-rXX configures the HARQ-ACK feedback type, it includes two possible values, e.g., ACK-NACK and NACK-only.

Example 134 includes the method of Example 132 or 133, wherein when harq-ACK-Type-rXX is set to ACK-NACK, either ACK or NACK is to be reported by UE depending on whether received PDSCH is correct or not.

Example 135 includes the method of Example 132 or 133, wherein when harq-ACK-Type-rXX is set to NACK-only, UE is to only report NACK when TB transmitted by PDSCH is not correctly received.

Example 136 includes the method of Example 127 or some other Example herein, wherein for a groupcast message of a predetermined importance level (e.g., if the message is critical) to all intended UEs in a group, if any UE in the group does not correctly receive the groupcast message, a gNB is to retransmit the message.

Example 137 includes the method of Example 136 or some other Example herein, wherein all the UEs in the group are configured with a same PUCCH resource and type-2 HARQ-ACK.

Example 138 includes the method of Example 127 or some other Example herein, wherein the method further comprises detecting, by a gNB, a reception status of each involved UE in a groupcast service.

Example 139 includes the method of Example 138 or some other Example herein, further comprising: determining, by the gNB, a multicast group based on UE link quality.

Example 140 includes the method of Example 127 or some other Example herein, further comprising arranging UEs with a similar link quality in a same multicast group; and selecting a modulation coding scheme for the multicast group.

Example 141 includes the method of Example 129 or some other Example herein, further comprising: configuring UEs with type-1 HARQ-ACK in the multicast group.

Example 142 includes a method comprising utilizing a configurable HARQ-ACK type for SPS transmission

Example 143 includes the method of Example 142 or some other Example herein, further comprising configuring either semi-static or dynamic HARQ-ACK feedback type by RRC signaling for SPS transmission.

Example 144 includes the method of Example 143 or some other Example herein, wherein the HARQ-ACK feedback type is explicitly configured by an RRC IE in SPS-Config as follows:

SPS-Config ::= SEQUENCE {
...,
[[
harq-ACK-Type-rXX ENUMERATED {dynamic, semi-static}
]]
},

wherein a harq-ACK-Type having a dynamic value is to configure the UE for dynamic HARQ-ACK feedback type and a harq-ACK-Type having a semi-static value is to configure the UE for semi-static HARQ-ACK feedback type.

Example 145 includes the method of Example 143 or some other Example herein, wherein semi-static HARQ-ACK feedback type is explicitly configured by an RRC IE in SPS-Config as in Example 1.6.

Example 146 includes the method of Example 143 or some other Example herein, wherein the UE is configured for dynamic HARQ-ACK feedback type by dynamic signaling in an SPS activation DCI by using a bit field in a part of PUCCH resource indicator.

Example 147 includes the method of Example 143 or some other Example herein, wherein the UE is configured with an SPS-Config IE as follows:

SPS-Config ::= SEQUENCE {
...,
[[
harq-ACK-Type-rXX CHOICE [
semi-static ENUMERATED {ACK-NACK, NACK-Only}
dynamic
}
]]
}.

Example 148 includes the method of Example 147 or some other Example herein, wherein parameter harq-ACK-Type-rXX configures the HARQ-ACK feedback type to be either semi-static or dynamic signaled.

Example 149 includes the method of Example 148 or some other Example herein, when harq-ACK-Type-rXX in Example 17 or some other Example herein, wherein is set to “semi-static”, either ACK-NACK or NACK-only HARQ-ACK feedback shall be used by the UE.

Example 150 includes the method of Example 147 or some other Example herein, wherein, when harq-ACK-Type-rXX is set to “dynamic,” a bit field, e.g., a first bit of DCI field PUCCH resource indicator, is to signal either ACK-NACK or NACK-only HARQ-ACK feedback.

Example 151 includes the method of Example 150 or some other Example herein, wherein when a value of the bit field is set to 0, ACK-NACK HARQ-ACK feedback is used.

Example 152 includes the method of Example 150 or some other Example herein, wherein when a value of the bit field is set to 1, NACK-only HARQ-ACK feedback is used.

Example 153 includes a method of transmitting, receiving, processing, or encoding a PUCCH resource that supports ACK-NACK or NACK-only feedback.

Example 154 includes the method of Example 153 or some other Example herein, wherein the PUCCH resource is to support either ACK-NACK or NACK-only transmission when it is configured with PUCCH format 0 or 1 for HARQ-ACK feedback.

Example 155 includes the method of Example 154 or some other Example herein, further comprising: setting or determining an indication in a PUCCH resource indicator field in DCI that indicates the PUCCH resource is configured for ACK-NAK feedback or NACK-only feedback.

Example 156 includes the method of Example 155 or some other Example herein, wherein the indication indicates the PUCCH resource is configured for ACK-NACK feedback and the method further comprises: generating, by a UE, ACK-NACK feedback for the HARQ-ACK response to a received PDSCH.

Example 157 includes the method of Example 155 or some other Example herein, wherein the indication indicates the PUCCH resource is configured for NACK-only feedback and the resource is chosen by the PUCCH resource indicator field in the DCI, wherein the method further comprises: transmitting, by a UE, NACK as HARQ-ACK feedback when the received PDSCH is not correctly decoded; and not transmitting HARQ-ACK feedback when the PDSCH is correctly decoded.

Example 158 includes the method of Example 153 or some other Example herein, wherein the PUCCH-Resource is defined follows:

PUCCH-Resource ::= SEQUENCE {
[[
harq-ACK-Type-rXX ENUMERATED {ACK-NACK, NACK-Only}
]]
......
}.

Example 159 includes the method of Example 158 or some other Example herein, wherein the parameter harq-ACK-Type-rXX configures the HARQ-ACK feedback type with one of two possible values, e.g., ACK-NACK and NACK-only.

Example 160 includes the method of Example 159 or some other Example herein, wherein when the parameter harq-ACK-Type-rXX is set to ACK-NACK, either ACK or NACK shall be reported by UE depending on whether received PDSCH is correctly decoded or not.

Example 161 includes the method of Example 159 or some other Example herein, wherein when the parameter harq-ACK-Type-rXX is set to NACK-only, the UE is to only report NACK when TB transmitted by PDSCH is not correctly received and not transmit any HARQ-ACK feedback when the TB transmitted by PDSCH is correctly received.

Example 162 includes the method of Example 153 or some other Example herein, further comprising: configuring a NACK-only HARQ-ACK response per PUCCH resource, and PUCCH resource can be chosen for any PDSCH transmission, which can be scheduled for aperiodic or periodic transmission with unicast or multicast messages.

Example 163 includes the method of Example 153 or some other Example herein, wherein based on HARQ-ACK feedback type, each PUCCH resource with format 0 or 1 can be allocated with proper radio resources according to the desired coverage of the PUCCH transmission.

Example 164 includes the method of Example 153 or some other Example herein, further comprising: allocating NACK-only PUCCH with more radio resources, e.g., longer sequence length, than ACK-NACK PUCCH.

Example 165 includes the method of Example 153 or some other Example herein, wherein allocating NACK-only PUCCH with more radio resources than ACK-NACK PUCCH is to provide same coverage for both.

Example Z01 includes an apparatus comprising means to perform one or more elements of a method described in or related to any of the method Examples above, or any other method or process described herein.

Example Z02 includes one or more non-transitory computer-readable media comprising instructions to cause an electronic device, upon execution of the instructions by one or more processors of the electronic device, to perform one or more elements of a method described in or related to any of the method Examples above, or any other method or process described herein.

Example Z03 includes an apparatus comprising logic, modules, or circuitry to perform one or more elements of a method described in or related to any of the method Examples above, or any other method or process described herein.

Example Z04 includes a method, technique, or process as described in or related to any of the method Examples above, or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of the Examples above, or portions thereof.

Example Z06 includes a signal as described in or related to any of the Examples above, or portions or parts thereof.

Example Z07 includes a datagram, packet, frame, segment, protocol data unit (PDU), or message as described in or related to any of the Examples above, or portions or parts thereof, or otherwise described in the present disclosure.

Example Z08 includes a signal encoded with data as described in or related to any of the Examples above, or portions or parts thereof, or otherwise described in the present disclosure.

Example Z09 includes a signal encoded with a datagram, packet, frame, segment, protocol data unit (PDU), or message as described in or related to any of the Examples above, or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of the method Examples above, or portions thereof.

Example Z11 includes a computer program comprising instructions, wherein execution of the program by a processing element is to cause the processing element to carry out the method, techniques, or process as described in or related to any of the method Examples above, or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

Any of the above-described Examples may be combined with any other Example (or combination of Examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the Examples and embodiments discussed herein.

| | | |
|---|---|---|
| 3GPP Third Generation | BLER Block Error Rate | CID Cell-ID (e.g., |
| Partnership Project | BPSK Binary Phase Shift | positioning method) |
| 4G Fourth Generation | Keying | CIM Common |
| 5G Fifth Generation | BRAS Broadband Remote | Information Model |
| 5GC 5G Core network | Access Server | CIR Carrier to |
| ACK Acknowledgement | BSS Business Support | Interference Ratio |
| AF Application | System | CK Cipher Key |
| Function | BS Base Station | CM Connection |
| AM Acknowledged | BSR Buffer Status | Management, Conditional |
| Mode | Report | Mandatory |
| AMBR Aggregate | BW Bandwidth | CMAS Commercial Mobile |
| Maximum Bit Rate | BWP Bandwidth Part | Alert Service |
| AMF Access and | C-RNTI Cell Radio Network | CMD Command |
| Mobility | Temporary Identity | CMS Cloud |
| Management | CA Carrier | Management System |
| Function | Aggregation, Certification | CO Conditional |
| AN Access Network | Authority | Optional |
| ANR Automatic | CAPEX CAPital | CoMP Coordinated Multi- |
| Neighbour Relation | EXpenditure | Point |
| AP Application | CBRA Contention Based | CORESET Control |
| Protocol, Antenna | Random Access | Resource Set |
| Port, Access Point | CC Component | COTS Commercial Off- |
| API Application | Carrier, Country | The-Shelf |
| Programming Interface | Code, Cryptographic | CP Control Plane, |
| APN Access Point Name | Checksum | Cyclic Prefix, Connection |
| ARP Allocation and | CCA Clear Channel | Point |
| Retention Priority | Assessment | CPD Connection Point |
| ARQ Automatic Repeat | CCE Control Channel | Descriptor |
| Request | Element | CPE Customer Premise |
| AS Access Stratum | CCCH Common Control | Equipment |
| ASN.1 Abstract Syntax | Channel | CPICH Common Pilot |
| Notation One | CE Coverage | Channel |
| AUSF Authentication | Enhancement | CQI Channel Quality |
| Server Function | CDM Content Delivery | Indicator |
| AWGN Additive White | Network | CPU CSI processing unit, |
| Gaussian Noise | CDMA Code-Division | Central Processing |
| BAP Backhaul | Multiple Access | Unit |
| Adaptation Protocol | CFRA Contention Free | C/R |
| BCH Broadcast Channel | Random Access | Command/Response |
| BER Bit Error Ratio | CG Cell Group | field bit |
| BFD Beam Failure | CI Cell Identity | EGMF Exposure |
| Detection | DC Dual Connectivity, | Governance |
| CRAN Cloud Radio Access | Direct Current | Management |
| Network, Cloud | DCI Downlink Control | Function |
| RAN | Information | EGPRS Enhanced GPRS |
| CRB Common Resource | DF Deployment | EIR Equipment Identity |
| Block | Flavour | Register |
| CRC Cyclic Redundancy | DL Downlink | eLAA enhanced Licensed |
| Check | DMTF Distributed | Assisted Access, |
| CRI Channel-State | Management Task Force | enhanced LAA |
| Information Resource | DPDK Data Plane | EM Element Manager |
| Indicator, CSI-RS | Development Kit | eMBB Enhanced Mobile |
| Resource Indicator | DM-RS, DMRS | Broadband |
| C-RNTI Cell RNTI | Demodulation | EMS Element |
| CS Circuit Switched | Reference Signal | Management System |
| CSAR Cloud Service | DN Data network | eNB evolved NodeB, E- |
| Archive | DRB Data Radio Bearer | UTRAN Node B |
| CSI Channel-State | DRS Discovery | EN-DC E-UTRA-NR Dual |
| Information | Reference Signal | Connectivity |
| CSI-IM CSI Interference | DRX Discontinuous | EPC Evolved Packet |
| Measurement | Reception | Core |
| CSI-RS CSI Reference | DSL Domain Specific | EPDCCH enhanced |
| Signal | Language. Digital | PDCCH, enhanced |
| CSI-RSRP CSI | Subscriber Line | Physical Downlink |
| reference signal | DSLAM DSL Access | Control Cannel |
| received power | Multiplexer | EPRE Energy per |
| CSI-RSRQ CSI | DwPTS Downlink Pilot | resource element |
| reference signal | Time Slot | EPS Evolved Packet |
| received quality | E-LAN Ethernet Local Area | System |
| CSI-SINR CSI signal- | Network | EREG enhanced REG, |
| to-noise and | E2E End-to-End | enhanced resource |
| interference ratio | ECCA extended clear | element groups |
| CSMA Carrier Sense | channel assessment, | ETSI European |
| Multiple Access | extended CCA | Telecommunications |
| CSMA/CA CSMA with | ECCE Enhanced Control | Standards Institute |
| collision avoidance | Channel Element, | ETWS Earthquake and |
| CSS Common Search | Enhanced CCE | Tsunami Warning |
| Space, Cell- specific | ED Energy Detection | System |
| Search Space | EDGE Enhanced | eUICC embedded UICC, |
| CTS Clear-to-Send | Datarates for GSM | embedded Universal |
| CW Codeword | Evolution (GSM | Integrated Circuit Card |
| CWS Contention | Evolution) | Communications, |
| Window Size | FFT Fast Fourier | Groupe Spécial |
| D2D Device-to-Device | Transformation | Mobile |
| E-UTRA Evolved | feLAA further enhanced | GTP GPRS Tunneling |
| UTRA | Licensed Assisted | Protocol |
| E-UTRAN Evolved | Access, further | GTP-U GPRS Tunnelling |
| UTRAN | enhanced LAA | Protocol for User |
| EV2X Enhanced V2X | FN Frame Number | Plane |
| F1AP F1 Application | FPGA Field- | GTS Go To Sleep Signal |
| Protocol | Programmable Gate | (related to WUS) |
| F1-C F1 Control plane | Array | GUMMEI Globally |
| interface | FR Frequency Range | Unique MME Identifier |
| F1-U F1 User plane | G-RNTI GERAN Radio | GUTI Globally Unique |
| interface | Network Temporary | Temporary UE Identity |
| FACCH Fast Associated | Identity | HARQ Hybrid ARQ, Hybrid |
| Control CHannel | GERAN GSM EDGE RAN, | Automatic Repeat |
| FACCH/F Fast | GSM EDGE Radio | Request |
| Associated Control | Access Network | HANDO Handover |
| Channel/Full rate | GGSN Gateway GPRS | HFN HyperFrame |
| FACCH/H Fast | Support Node | Number |
| Associated Control | GLONASS | HHO Hard Handover |
| Channel/Half rate | GLObal'naya | HLR Home Location |
| FACH Forward Access | NAvigatsionnaya | Register |
| Channel | Sputnikovaya | HN Home Network |
| FAUSCH Fast Uplink | Sistema (Engl.: | HO Handover |
| Signalling Channel | Global Navigation | HPLMN Home |
| FB Functional Block | Satellite System) | Public Land Mobile |
| FBI Feedback | gNB Next Generation | Network |
| Information | NodeB | HSDPA High Speed |
| FCC Federal | gNB-CU gNB- | Downlink Packet |
| Communications | centralized unit, Next | Access |
| Commission | Generation NodeB | HSN Hopping Sequence |
| FCCH Frequency | centralized unit | Number |
| Correction CHannel | gNB-DU gNB- | HSPA High Speed Packet |
| FDD Frequency Division | distributed unit, Next | Access |
| Duplex | Generation NodeB | HSS Home Subscriber |
| FDM Frequency Division | distributed unit | Server |
| Multiplex | GNSS Global Navigation | HSUPA High Speed Uplink |
| FDMA Frequency Division | Satellite System | Packet Access |
| Multiple Access | GPRS General Packet | HTTP Hyper Text |
| FE Front End | Radio Service | Transfer Protocol |
| FEC Forward Error | GSM Global System for | kB Kilobyte (1000 |
| Correction | Mobile | bytes) |
| FFS For Further Study | IMPI IP Multimedia | kbps kilo-bits per second |
| HTTPS Hyper Text | Private Identity | Kc Ciphering key |
| Transfer Protocol | IMPU IP Multimedia | Ki Individual |
| Secure (https is | PUblic identity | subscriber |
| http/1.1 over SSL, | IMS IP Multimedia | authentication key |
| i.e. port 443) | Subsystem | KPI Key Performance |
| I-Block Information Block | IMSI International | Indicator |
| ICCID Integrated Circuit | Mobile Subscriber | KQI Key Quality |
| Card Identification | Identity | Indicator |
| IAB Integrated Access | IoT Internet of Things | KSI Key Set Identifier |
| and Backhaul | IP Internet Protocol | ksps kilo-symbols per |
| ICIC Inter-Cell | Ipsec IP Security, | second |
| Interference | Internet Protocol | KVM Kernel Virtual |
| Coordination | Security | Machine |
| ID Identity, identifier | IP-CAN IP-Connectivity | L1 Layer 1 (physical |
| IDFT Inverse Discrete | Access Network | layer) |
| Fourier Transform | IP-M IP Multicast | L1-RSRP Layer 1 |
| IE Information | IPv4 Internet Protocol | reference signal |
| element | Version 4 | received power |
| IBE In-Band Emission | IPv6 Internet Protocol | L2 Layer 2 (data link |
| IEEE Institute of | Version 6 | layer) |
| Electrical and Electronics | IR Infrared | L3 Layer 3 (network |
| Engineers | IS In Sync | layer) |
| IEI Information | IRP Integration | LAA Licensed Assisted |
| Element Identifier | Reference Point | Access |
| IEIDL Information | ISDN Integrated Services | LAN Local Area Network |
| Element Identifier | Digital Network | LBT Listen Before Talk |
| Data Length | ISIM IM Services | LCM LifeCycle |
| IETF Internet | Identity Module | Management |
| Engineering Task | ISO International | LCR Low Chip Rate |
| Force | Organisation for | LCS Location Services |
| IF Infrastructure | Standardisation | LCID Logical Channel |
| IM Interference | ISP Internet Service | ID |
| Measurement, | Provider | LI Layer Indicator |
| Intermodulation, IP | IWF Interworking- | LLC Logical Link |
| Multimedia | Function | Control, Low Layer |
| IMC IMS Credentials | I-WLAN | Compatibility |
| IMEI International | Interworking WLAN | LPLMN Local PLMN |
| Mobile Equipment | Constraint length | LPP LTE Positioning |
| Identity | of the convolutional code, | Protocol |
| IMGI International | USIM Individual key | MPRACH MTC |
| mobile group identity | MCS Modulation and | Physical Random |
| LSB Least Significant Bit | coding scheme | Access CHannel |
| LTE Long Term | MDAF Management Data | MPUSCH MTC |
| Evolution | Analytics Function | Physical Uplink Shared |
| LWA LTE-WLAN | MDAS Management Data | Channel |
| aggregation | Analytics Service | MPLS MultiProtocol Label |
| LWIP LTE/WLAN Radio | MDT Minimization of | Switching |
| Level Integration with | Drive Tests | MS Mobile Station |
| IPsec Tunnel | ME Mobile Equipment | MSB Most Significant Bit |
| LTE Long Term | MeNB master eNB | MSC Mobile Switching |
| Evolution | MER Message Error | Centre |
| M2M Machine-to- | Ratio | MSI Minimum System |
| Machine | MGL Measurement Gap | Information, MCH |
| MAC Medium Access | Length | Scheduling |
| Control (protocol | MGRP Measurement Gap | Information |
| layering context) | Repetition Period | MSID Mobile Station |
| MAC Message | MIB Master Information | Identifier |
| authentication code | Block, Management | MSIN Mobile Station |
| (security/encryption | Information Base | Identification |
| context) | MIMO Multiple Input | Number |
| MAC-A MAC used for | Multiple Output | MSISDN Mobile |
| authentication and | MLC Mobile Location | Subscriber ISDN |
| key agreement (TSG T | Centre | Number |
| WG3 context) | MM Mobility | MT Mobile |
| MAC-I MAC used for data | Management | Terminated, Mobile |
| integrity of signalling | MME Mobility | Termination |
| messages (TSG T | Management Entity | MTC Machine-Type |
| WG3 context) | MN Master Node | Communications |
| MANO Management and | MnS Management | mMTC massive MTC, |
| Orchestration | Service | massive Machine- |
| MBMS Multimedia | MO Measurement | Type Communications |
| Broadcast and | Object, Mobile | MU-MIMO Multi User |
| Multicast Service | Originated | MIMO |
| MBSFNMultimedia | MPBCH MTC | MWUS MTC wake-up |
| Broadcast multicast | Physical Broadcast | signal, MTC WUS |
| service Single Frequency | CHannel | NACK Negative |
| Network | MPDCCH MTC | Acknowledgement |
| MCC Mobile Country | Physical Downlink | NAI Network Access |
| Code | Control CHannel | Identifier |
| MCG Master Cell Group | MPDSCH MTC | NWUS Narrowband wake- |
| MCOT Maximum Channel | Physical Downlink | up signal, Narrowband |
| Occupancy Time | Shared CHannel | WUS |
| NAS Non-Access | NPDSCH | NZP Non-Zero Power |
| Stratum, Non- Access | Narrowband | O&M Operation and |
| Stratum layer | Physical Downlink | Maintenance |
| NCT Network | Shared CHannel | ODU2 Optical channel |
| Connectivity Topology | NPRACH | Data Unit - type 2 |
| NC-JT Non-Coherent | Narrowband | OFDM Orthogonal |
| Joint Transmission | Physical Random | Frequency Division |
| NEC Network Capability | Access CHannel | Multiplexing |
| Exposure | NPUSCH | OFDMA Orthogonal |
| NE-DC NR-E-UTRA Dual | Narrowband | Frequency Division |
| Connectivity | Physical Uplink | Multiple Access |
| NEF Network Exposure | Shared CHannel | OOB Out-of-band |
| Function | NPSS Narrowband | OOS Out of Sync |
| NF Network Function | Primary | OPEX OPerating EXpense |
| NFP Network | Synchronization | OSI Other System |
| Forwarding Path | Signal | Information |
| NFPD Network | NSSS Narrowband | OSS Operations Support |
| Forwarding Path | Secondary | System |
| Descriptor | Synchronization | OTA over-the-air |
| NFV Network Functions | Signal | PAPR Peak-to-Average |
| Virtualization | NR New Radio, | Power Ratio |
| NFVI NFV Infrastructure | Neighbour Relation | PAR Peak to Average |
| NFVO NFV Orchestrator | NRF NF Repository | Ratio |
| NG Next Generation, | Function | PBCH Physical Broadcast |
| Next Gen | NRS Narrowband | Channel |
| NGEN-DC NG-RAN E- | Reference Signal | PC Power Control, |
| UTRA-NR Dual | NS Network Service | Personal Computer |
| Connectivity | NSA Non-Standalone | PCC Primary |
| NM Network Manager | operation mode | Component Carrier, |
| NMS Network | NSD Network Service | Primary CC |
| Management System | Descriptor | PCell Primary Cell |
| N-PoP Network Point of | NSR Network Service | PCI Physical Cell ID, |
| Presence | Record | Physical Cell Identity |
| NMIB, N-MIB Narrowband | NSSAI Network Slice | PCEF Policy and Charging |
| MIB | Selection Assistance | Enforcement |
| NPBCH Narrowband | Information | Function |
| Physical Broadcast | S-NNSAI Single- | PCF Policy Control |
| CHannel | NSSAI | Function |
| NPDCCH | NSSF Network Slice | QCI QoS class of |
| Narrowband | Selection Function | identifier |
| Physical Downlink | NW Network | QCL Quasi co-location |
| Control CHannel | PP, PTP Point-to- | QFI QoS Flow ID, QoS |
| PCRF Policy Control and | Point | Flow Identifier |
| Charging Rules | PPP Point-to-Point | QoS Quality of Service |
| Function | Protocol | QPSK Quadrature |
| PDCP Packet Data | PRACH Physical RACH | (Quaternary) Phase Shift |
| Convergence Protocol, | PRB Physical resource | Keying |
| Packet Data | block | QZSS Quasi-Zenith |
| Convergence | PRG Physical resource | Satellite System |
| Protocol layer | block group | RA-RNTI Random |
| PDCCH Physical Downlink | ProSe Proximity Services, | Access RNTI |
| Control Channel | Proximity-Based | RAB Radio Access |
| PDCP Packet Data | Service | Bearer, Random |
| Convergence Protocol | PRS Positioning | Access Burst |
| PDN Packet Data | Reference Signal | RACH Random Access |
| Network, Public Data | PRR Packet Reception | Channel |
| Network | Radio | RADIUS Remote |
| PDSCH Physical Downlink | PS Packet Services | Authentication Dial In |
| Shared Channel | PSBCH Physical Sidelink | User Service |
| PDU Protocol Data Unit | Broadcast Channel | RAN Radio Access |
| PEI Permanent | PSDCH Physical Sidelink | Network |
| Equipment Identifiers | Downlink Channel | RAND RANDom number |
| PFD Packet Flow | PSCCH Physical Sidelink | (used for |
| Description | Control Channel | authentication) |
| P-GW PDN Gateway | PSFCH Physical Sidelink | RAR Random Access |
| PHICH Physical hybrid- | Feedback Channel | Response |
| ARQ indicator channel | PSSCH Physical Sidelink | RAT Radio Access |
| PHY Physical layer | Shared Channel | Technology |
| PLMN Public Land Mobile | PSCell Primary SCell | RAU Routing Area |
| Network | PSS Primary | Update |
| PIN Personal | Synchronization | RB Resource block, |
| Identification Number | Signal | Radio Bearer |
| PM Performance | PSTN Public Switched | RBG Resource block |
| Measurement | Telephone Network | group |
| PMI Precoding Matrix | PT-RS Phase-tracking | REG Resource Element |
| Indicator | reference signal | Group |
| PNF Physical Network | PTT Push-to-Talk | Rel Release |
| Function | PUCCH Physical Uplink | REQ REQuest |
| PNFD Physical Network | Control Channel | RF Radio Frequency |
| Function Descriptor | PUSCH Physical Uplink | RI Rank Indicator |
| PNFR Physical Network | Shared Channel | SCG Secondary Cell |
| Function Record | QAM Quadrature | Group |
| POC PTT over Cellular | Amplitude Modulation | SCM Security Context |
| RIV Resource indicator | RSSI Received Signal | Management |
| value | Strength Indicator | SCS Subcarrier Spacing |
| RL Radio Link | RSU Road Side Unit | SCTP Stream Control |
| RLC Radio Link Control, | RSTD Reference Signal | Transmission |
| Radio Link Control layer | Time difference | Protocol |
| RLC AM RLC | RTP Real Time Protocol | SDAP Service Data |
| Acknowledged Mode | RTS Ready-To-Send | Adaptation Protocol, |
| RLC UM RLC | RTT Round Trip Time | Service Data Adaptation |
| Unacknowledged Mode | Rx Reception, | Protocol layer |
| RLF Radio Link Failure | Receiving, Receiver | SDL Supplementary |
| RLM Radio Link | S1AP S1 Application | Downlink |
| Monitoring | Protocol | SDNF Structured Data |
| RLM-RS Reference | S1-MME S1 for the | Storage Network |
| Signal for RLM | control plane | Function |
| RM Registration | S1-U S1 for the user | SDP Session Description |
| Management | plane | Protocol |
| RMC Reference | S-GW Serving Gateway | SDSF Structured Data |
| Measurement Channel | S-RNTI SRNC Radio | Storage Function |
| RMSI Remaining MSI, | Network Temporary | SDU Service Data Unit |
| Remaining Minimum | Identity | SEAF Security Anchor |
| System Information | S-TMSI SAE Temporary | Function |
| RN Relay Node | Mobile Station | SeNB secondary eNB |
| RNC Radio Network | Identifier | SEPP Security Edge |
| Controller | SA Standalone | Protection Proxy |
| RNL Radio Network | operation mode | SFI Slot format |
| Layer | SAE System | indication |
| RNTI Radio Network | Architecture Evolution | SFTD Space-Frequency |
| Temporary Identifier | SAP Service Access | Time Diversity, SFN and |
| ROHC RObust Header | Point | frame timing difference |
| Compression | SAPD Service Access | SFN System Frame |
| RRC Radio Resource | Point Descriptor | Number or |
| Control, Radio | SAPI Service Access | Single Frequency |
| Resource Control | Point Identifier | Network |
| layer | SCC Secondary | SgNB Secondary gNB |
| RRM Radio Resource | Component Carrier, | SGSN Serving GPRS |
| Management | Secondary CC | Support Node |
| RS Reference Signal | SCell Secondary Cell | S-GW Serving Gateway |
| RSRP Reference Signal | SC-FDMA Single | SI System |
| Received Power | Carrier Frequency | Information |
| RSRQ Reference Signal | Division Multiple | TCI Transmission |
| Received Quality | Access | Configuration Indicator |
| SI-RNTISystem | SSBRI SSB Resource | TCP Transmission |
| Information RNTI | Indicator | Communication |
| SIB System | SSC Session and Service | Protocol |
| Information Block | Continuity | TDD Time Division |
| SIM Subscriber Identity | SS-RSRP | Duplex |
| Module | Synchronization | TDM Time Division |
| SIP Session Initiated | Signal based Reference | Multiplexing |
| Protocol | Signal Received | TDMA Time Division |
| SiP System in Package | Power | Multiple Access |
| SL Sidelink | SS-RSRQ | TE Terminal |
| SLA Service Level | Synchronization | Equipment |
| Agreement | Signal based Reference | TEID Tunnel End Point |
| SM Session | Signal Received | Identifier |
| Management | Quality | TFT Traffic Flow |
| SMF Session | SS-SINR | Template |
| Management Function | Synchronization | TMSI Temporary Mobile |
| SMS Short Message | Signal based Signal to | Subscriber Identity |
| Service | Noise and Interference | TNL Transport Network |
| SMSF SMS Function | Ratio | Layer |
| SMTC SSB-based | SSS Secondary | TPC Transmit Power |
| Measurement Timing | Synchronization | Control |
| Configuration | Signal | TPMI Transmitted |
| SN Secondary Node, | SSSG Search Space Set | Precoding Matrix |
| Sequence Number | Group | Indicator |
| SoC System on Chip | SSSIF Search Space Set | TR Technical Report |
| SON Self-Organizing | Indicator | TRP, TRxP |
| Network | SST Slice/Service Types | Transmission |
| SpCell Special Cell | SU-MIMO Single User | Reception Point |
| SP-CSI-RNTISemi- | MIMO | TRS Tracking Reference |
| Persistent CSI RNTI | SUL Supplementary | Signal |
| SPS Semi-Persistent | Uplink | TRx Transceiver |
| Scheduling | TA Timing Advance, | TS Technical |
| SQN Sequence number | Tracking Area | Specifications, |
| SR Scheduling Request | TAC Tracking Area Code | Technical Standard |
| SRB Signalling Radio | TAG Timing Advance | TTI Transmission Time |
| Bearer | Group | Interval |
| SRS Sounding | TAU Tracking Area | Tx Transmission, |
| Reference Signal | Update | Transmitting, |
| SS Synchronization | TB Transport Block | Transmitter |
| Signal | TBS Transport Block | VNFFGD VNF |
| SSB SS Block | Size | Forwarding Graph |
| U-RNTI UTRAN Radio | TBD To Be Defined | Descriptor |
| Network Temporary | URL Uniform Resource | VNFM VNF Manager |
| Identity | Locator | VoIP Voice-over-IP, |
| UART Universal | URLLC Ultra-Reliable and | Voice-over-Internet |
| Asynchronous Receiver | Low Latency | Protocol |
| and Transmitter | USB Universal Serial Bus | VPLMN Visited |
| UCI Uplink Control | USIM Universal | Public Land Mobile |
| Information | Subscriber Identity | Network |
| UE User Equipment | Module | VPN Virtual Private |
| UDM Unified Data | USS UE-specific search space | Network |
| Management | UTRA UMTS Terrestrial | VRB |
| UDP User Datagram | Radio Access | Virtual Resource |
| Protocol | UTRANUniversal | Block |
| UDR Unified Data | Terrestrial Radio | WiMAX Worldwide |
| Repository | Access Network | Interoperability for |
| UDSF Unstructured Data | UwPTS Uplink Pilot Time | Microwave Access |
| Storage Network | Slot | WLAN Wireless Local Area |
| Function | V2I Vehicle-to- | Network |
| UICC Universal | Infrastruction | WMAN Wireless |
| Integrated Circuit Card | V2P Vehicle-to- | Metropolitan Area |
| UL Uplink | Pedestrian | Network |
| UM Unacknowledged | V2V Vehicle-to-Vehicle | WPAN Wireless Personal |
| Mode | V2X Vehicle-to- | Area Network |
| UML Unified Modelling | everything | X2-C X2-Control plane |
| Language | VIM Virtualized | X2-U X2-User plane |
| UMTS Universal Mobile | Infrastructure Manager | XML eXtensible Markup |
| Telecommunications | VL Virtual Link, | Language |
| System | VLAN Virtual LAN, Virtual | XRES EXpected user |
| UP User Plane | Local Area Network | RESponse |
| UPF User Plane | VM Virtual Machine | XOR eXclusive OR |
| Function | VNF Virtualized | ZC Zadoff-Chu |
| URI Uniform Resource | Network Function | ZP Zero Power |
| Identifier | VNFFG VNF Forwarding | |
| | Graph | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

What is claimed is:

1. An apparatus of a New Radio (NR) evolved Node B (gNB), the apparatus including one or more processing circuitries including a digital baseband processing circuitry, and a protocol processing circuitry coupled to the digital baseband processing circuitry, the one or more circuitries to:
encode for transmission to one or more user equipments (UEs) a radio resource control (RRC) message including at least one of:
one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or
a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and
cause transmission to the one or more UEs of the RRC message to configure the one or more UEs with one or more respective SPS configurations.

2. The apparatus of claim 1, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

3. The apparatus of claim 2, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

4. The apparatus of claim 3, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

5. The apparatus of claim 3, the cs-RNTIList defines a list of the one or more CS-RNTIs being configured to the one or more UEs for the physical cell group, each CS-RNT value in the list corresponding to one of a unicast type, a multicast/groupcast type, or a broadcast type.

6. The apparatus of claim 1, wherein, when the RRC message includes the one or more CS-RNTIs, the one CS-RNTI is to schedule a unicast DL SPS transmission, and the plurality of CS-RNTIs are to schedule groupcast SPS transmissions for different groups of UEs, wherein the one or more UEs are to be part of a serving cell including multiple groupcast groups of UEs, each group of the multiple groups containing either non-overlapped UEs or a partially overlapped set of UEs, and wherein the plurality of CS-RNTIs includes a same CS-RNTI value to correspond to all UEs in a same group of the multiple groupcast groups of UEs.

7. The apparatus of claim 6, wherein the plurality of CS-RNTIs includes different CS-RNTI values to configure a same UE of the one or more UEs based on a number of groups of the multiple groupcast groups that the same UE belongs to.

8. The apparatus of claim 1, wherein, when the parameters defining an index of associated CS-RNTI SPS-ConfigIndex are not configured in SPS-Config, a default value of cs-RNTI-id is to be set to 1, and dataScramblingIdentityPDSCH, and dataScramblingIdentityPDSCH2 are to correspond to respective corresponding parameters configured in a physical downlink shared channel (PDSCH) configuration message, PDSCH-Config, in a same bandwidth part, cs-RNTI-id corresponding to a CS-RNTI used for unicast SPS DL transmission.

9. The apparatus of claim 2, wherein the cs-RNTI identification parameter comprises a cs-RNTI-id-rXX parameter including one or more cs-RNTI-ids corresponding to an integer number from 1 to a maximum number of CS-RNTIs, maxNrofCS-RNTI, specifying a maximum number of CS-RNTI supported, a dataScramblingIdentityPDSCH-rXX parameter corresponding to an integer number from 1 to 1023, and a dataScramblingIdentityPDSCH-rXX2 parameter corresponding to an integer number from 1 to 1023.

10. The apparatus of claim 9, wherein sps-ConfigIndex-rXX is numbered within a SPS-Config group corresponding to a same CS-RNTI, sps-ConfigIndex-rXXs in two SPS-Configs being configured with different CS-RNTIs while sharing a same number value, and a hybrid automatic repeat request (HARQ) process identification (ProcID) offset parameter, harq-ProcID-Offset-r16, including different number values to correspond to non-overlapped HARQ process ID spaces for different SPS-Configs corresponding to different CS-RNTI.

11. The apparatus of claim 9, wherein the one or more circuitries are to scramble a downlink control information message (DCI) with CS-RNTI identified by cs-RNTI-id-rXX, the SPS-Config with the sps-ConfigIndex-rXX is signaled in the DCI and is addressed for activation/release/retransmission.

12. The apparatus of claim 11, wherein the CS-RNTI identified by cs-RNTI-id-rXX is associated with n_{RNTI} to generate a PDSCH data scrambling sequence.

13. The apparatus of claim 12, wherein parameter n_{ID}∈{0,1, . . . , 1023} used for PDSCH data scrambling sequence generation is based on dataScramblingIdentityPDSCH-rXX.

14. The apparatus of claim 1, the one or more circuitries to further process information from a core network regarding the one or more CS-RNTI or the SPS-Config, and encoding based on the information from the core network.

15. The apparatus of claim 1, further including a radio front end circuitry coupled to the one or more circuitries, and one or more antennas coupled to the radio front end circuitry to transmit and receive wireless signals.

16. A method to be performed at a New Radio (NR) evolved Node B (gNB) including:
encoding for transmission to one or more user equipments (UEs) a radio resource control (RRC) message including at least one of:
one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or
a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and
causing transmission to the one or more UEs of the RRC message to configure the one or more UEs with one or more respective SPS configurations.

17. The method of claim 16, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

18. The method of claim 17, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

19. The method of claim 18, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

20. A non-transitory machine-readable storage medium comprising instructions to cause an device of a New Radio (NR) evolved Node B (gNB), upon execution of the instructions by one or more circuitries of the device, to perform operations including:
encoding for transmission to one or more user equipments (UEs) a radio resource control (RRC) message including at least one of:
one or more configured scheduling radio network temporary identifiers (CS-RNTIs) including one of: one CS-RNTI to activate, deactivate or retransmit a semi-persistent scheduling (SPS) grant for unicast downlink (DL) transmission when the one or more UEs include one UE, or a plurality of CS-RNTIs to activate, deactivate or retransmit a respective plurality of SPS grants for multicast DL transmission when the one or more UEs include a plurality of UEs; or
a semi-persistent scheduling configuration message SPS-Config including parameters defining an index of associated CS-RNTI SPS-ConfigIndex including a cs-RNTI-identification (cs-RNTI-id) parameter and downlink scheduling PDSCH data scrambling identifications, the downlink scheduling PDSCH data scrambling identifications including a parameter dataScramblingIdentityPDSCH, and an optional parameter dataScramblingIdentityPDSCH2; and
causing transmission to the one or more UEs of the RRC message to configure the one or more UEs with one or more respective SPS configurations.

21. The machine-readable storage medium of claim 20, wherein, when the RRC message includes the one or more CS-RNTIs, each of the plurality of CS-RNTIs is associated with a respective SPS configuration of a group of SPS configurations, and a SPS-ConfigIndex parameter of the RRC message is numbered within a group of SPS configurations associated with a same CS-RNTI.

22. The machine-readable storage medium of claim 21, wherein, when the RRC message includes the one or more CS-RNTIs, the RRC message includes a RRC information element (IE) to configure a physical cell group defining the one or more UEs, PhysicalCellGroupConfig, and including a sequence comprising a list of the one or more CS-RNTIs, cs-RNTIList, and a sequence of CS-RNTIType defining respective types for the one or more CS-RNTIs, the sequence of CS-RNTIType having a size from 1 to a maximum number of CS-RNTI supported, maxNrofCSRNTI.

23. The machine-readable storage medium of claim 22, wherein, when the RRC message includes the one or more CS-RNTIs, the RRC message includes a cs-RNTI-identification (cs-RNTI-id) parameter, cs-RNTI-id, and an index of the CS-RNTI configured for a UE is used to identify respective RNTIs in other RRC configuration IEs.

24. The machine-readable storage medium of claim 23, wherein, when the RRC message includes the one or more CS-RNTIs, the RRC message includes a parameter maxNrofCS-RNTI specifying a maximum number of CS-RNTI supported.

25. The machine-readable storage medium of claim 23, the cs-RNTIList defines a list of the one or more CS-RNTIs being configured to the one or more UEs for the physical cell group, each CS-RNT value in the list corresponding to one of a unicast type, a multicast/groupcast type, or a broadcast type.
